(19) United States
(12) Patent Application Publication
(10) Pub. No.: US 2026/0368559 A1
(43) Pub. Date: Nov. 19, 2026

(54) SYSTEMS AND METHODS FOR GOVERNED CONTINUITY, CONTEXTUAL RELEVANCE DECAY, AND CONSENT-GATED CONTEXT RE-ENTRY IN LONGITUDINAL ARTIFICIAL INTELLIGENCE SYSTEMS

(71) Applicant: KERRY DAWANN NEAL, Mansfield, TX (US)

(72) Inventor: KERRY DAWANN NEAL, Mansfield, TX (US)

(21) Appl. No.: 19/536,547

(22) Filed: Feb. 11, 2026

Related U.S. Application Data
(60) Provisional application No. 63/975,826, filed on Feb. 4, 2026.

(51) Int. Cl. G06N 5/04

(52) U.S. Cl. CPC G06N 5/04

(57) ABSTRACT

An artificial intelligence system for longitudinal continuity is disclosed. The system stores contextual signals as context records in persistent storage and enforces runtime governance constraints that condition storage, retrieval, and presentation of the records. A relevance decay mechanism attenuates a relevance value of each record as a function of time and other factors, causing records to become dormant. Reconstruction of dormant context is gated by an affirmative consent signal through a consent mediation module, and the system is permitted to enter a silence state that withholds proactive resurfacing absent a user request. By filtering retrieval candidates prior to retrieval optimization and excluding dormant records, the system reduces retrieval latency and prevents authority accretion in persistent AI interactions.

### CROSS-REFERENCE TO RELATED APPLICATIONS

This application claims the benefit of U.S. Provisional Patent Application No. 63/937,386, filed Nov. 14, 2025, and U.S. Provisional Patent Application No. 63/975,826, filed Feb. 4, 2026. The entire contents of each are incorporated herein by reference.

### STATEMENT REGARDING FEDERALLY SPONSORED RESEARCH OR DEVELOPMENT

Not applicable.

### FIELD OF THE INVENTION

The present disclosure relates to artificial intelligence systems and, more particularly, to longitudinal artificial intelligence systems that maintain user context across interaction sessions while controlling contextual persistence, retrieval, and presentation using enforceable runtime governance constraints, relevance decay, and consent-gated reconstruction.

### BACKGROUND OF THE INVENTION

Persistent artificial intelligence systems that retain contextual information across interaction boundaries can experience technical failure modes. Example failure modes include uncontrolled accumulation of stored context, escalating system-initiated behavior as memory density increases, retrieval inefficiency and increased latency, resurfacing of stale or low-relevance context, and erosion of user interpretive control. Existing systems often treat contextual persistence as a capability enhancement without introducing infrastructure-level mechanisms that constrain how persistence influences downstream retrieval and output. In practice, memory persistence can shift system behavior toward increasingly proactive or interventionist outputs, including resurfacing information at times that are not aligned with the user's intent or consent. There remains a need for systems that preserve longitudinal continuity while constraining authority accretion and reducing retrieval overhead.

### SUMMARY OF THE INVENTION

The invention provides a governance-first artificial intelligence system that enforces constraints on contextual persistence, retrieval, and presentation. The system applies relevance decay over time and conditions reconstruction of dormant or decayed context on affirmative user consent. In some embodiments, governance is enforced at an infrastructure layer that operates independently of model capability, model accuracy, or model preferences. In certain embodiments, contextual signals are stored as context records with metadata that includes, by way of example and not limitation, a timestamp, a source domain identifier, a decay parameter, a contradiction indicator, and a consent state. During retrieval, the system evaluates the metadata against governance constraints to determine whether a context record is eligible to be reconstructed into an active context window for an interaction session. By limiting retrieval to eligible context records, the system can reduce computational retrieval load, reduce resurfacing of stale context, and preserve user interpretive control over when and how prior context is re-entered.

### BRIEF DESCRIPTION OF THE DRAWINGS

The accompanying drawings, which are incorporated in and constitute a part of this specification, illustrate embodiments of the invention and, together with the description, explain principles of the invention.

FIG. 1 illustrates an example authority accretion pathway in a persistent system without governance.

FIG. 2 illustrates an example governance layer intercept that conditions context storage and retrieval.

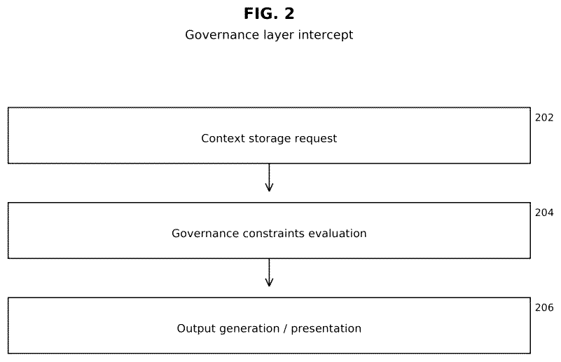

FIG. 3 illustrates an example relevance decay of a stored context record over time.

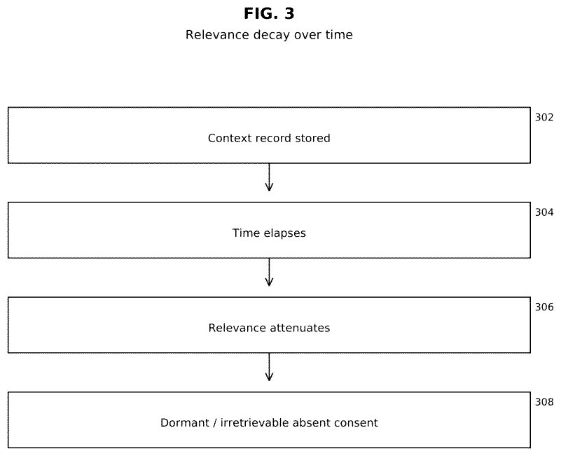

FIG. 4 illustrates an example consent-gated reconstruction of dormant context.

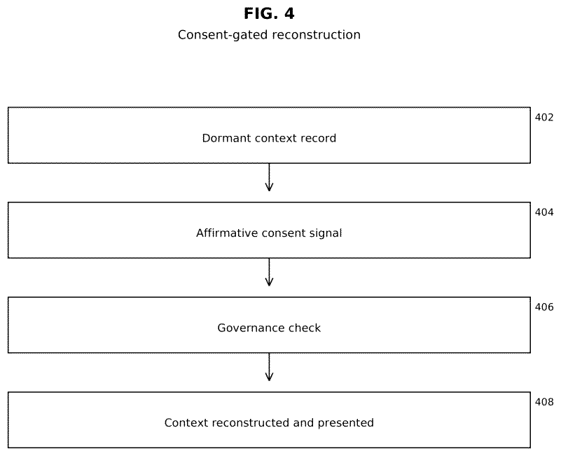

FIG. 5 illustrates an example governance-constrained lifecycle of contextual signals.

FIG. 6 illustrates an example system architecture for a governed continuity intelligence system.

### DETAILED DESCRIPTION OF THE INVENTION

Reference will now be made in detail to illustrative embodiments of the invention, examples of which are shown in the accompanying drawings. The embodiments are described to explain the invention, not to limit it. Many alternatives, modifications, and variations will be apparent to those skilled in the art. As used herein, the term “governed continuity intelligence system” refers to a longitudinal artificial intelligence system that preserves continuity across time by storing contextual signals across interaction sessions, while enforcing runtime governance constraints that condition what context is stored, what context is retrieved, and how retrieved context is presented to a user.

### Operational Definition of Governance

Governance refers to enforceable system logic applied at runtime that conditions storage, retrieval, and presentation of contextual signals. Governance is operational rather than aspirational. In some embodiments, governance is enforced at an infrastructure level that is separate from a model inference engine such that governance decisions can be applied regardless of model behavior, model accuracy, or model preferences.

### DEFINITIONS AND TERMINOLOGY

For clarity, the following terms are used throughout this disclosure: (1) “Contextual signal” means any data item that may inform continuity across sessions, including user-provided content (e.g., messages), system-observed events (e.g., interaction timestamps), and external-domain signals (e.g., institutional inputs). (2) “Context record” means a stored representation of a contextual signal that includes a payload and metadata. (3) “Governance policy” or “constitution” means a machine-readable set of governance constraints enforced by a governance layer at runtime. (4) “Relevance decay” means attenuation of an eligibility or relevance value associated with a context record as a function of time and/or other factors. (5) “Consent state” means a stored value indicating whether a context record is eligible for reconstruction without additional consent, requires affirmative consent, or is denied. (6) “Reconstruction” means transforming one or more stored context records into active context that may be presented to a user or provided to a model inference engine for output generation. (7) “Silence state” means an operational state in which the system generates no proactive output and/or withholds resurfacing dormant context absent a user request or affirmative consent. (8) “Authority accretion” means an increase in system-initiated interventions attributable to the presence of persistent context, which may be measured as a rate, count, or score of system-initiated actions over time.

### System Architecture

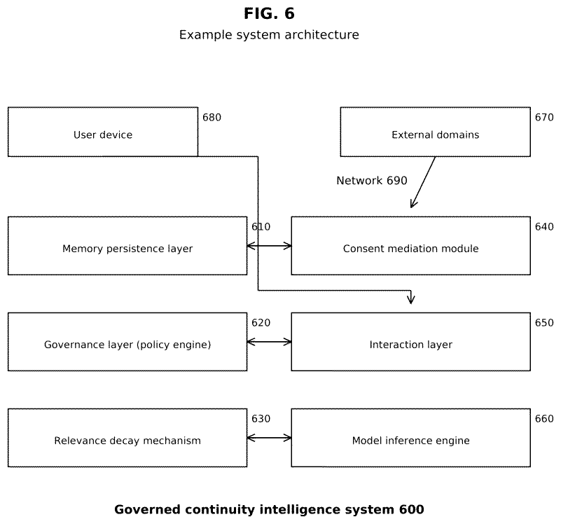

FIG. 6 illustrates an example architecture of a governed continuity intelligence system 600. In the illustrated embodiment, the system 600 includes a memory persistence layer 610, a governance layer 620, a relevance decay mechanism 630, a consent mediation module 640, an interaction layer 650, and a model inference engine 660. The system 600 may communicate with one or more external domains 670 (e.g., institutional sources) and may provide outputs to a user device 680 via a network 690. In some embodiments, the memory persistence layer 610 stores context records in a database, object store, or other persistent storage. The governance layer 620 is configured to evaluate governance constraints before a context record is stored, retrieved, or presented. The relevance decay mechanism 630 updates or computes relevance values for stored context records. The consent mediation module 640 manages consent prompts, consent tokens, or other indicators of affirmative user consent. The interaction layer 650 manages session context windows, including determining whether a silence state is appropriate. The model inference engine 660 may be any language model or other machine learning model used to generate outputs. Although FIG. 6 illustrates a particular arrangement, the components may be combined, separated, distributed, or implemented in different computing environments (e.g., on-device, server-side, or hybrid).

### Context Record Data Structure

In some embodiments, contextual signals are stored as context records having a payload and metadata. Table 1 provides a non-limiting example of metadata fields that may be stored with each context record.

TABLE 1
Example context record metadata

| Field | Description | Example / Notes |
|---|---|---|
| timestamp | Time associated with capture | e.g., UTC epoch or |
| | or last reaffirmation of the | ISO-8601 |
| | contextual signal. | |
| source_domain_{—} | Identifier of the source | e.g., user, device, |
| id | domain for the signal. | institutional source |
| decay_parameter | Parameter used by the | e.g., lambda |
| | relevance decay mechanism | coefficient |
| | to compute relevance over | |
| | time. | |
| contradiction_{—} | Indicator that the signal is | e.g., boolean or |
| indicator | contradicted, stale, or | categorical |
| | superseded. | |
| consent_state | State indicating whether | allowed / required / |
| | reconstruction is allowed, | denied |
| | requires consent, or is denied. | |
| relevance_value | Computed relevance value | computed at retrieval |
| | used to determine retrieval | or periodically |
| | eligibility. | |

### Governance Policy and Enforcement Points

In some embodiments, the governance layer 620 enforces a governance policy (also referred to as a constitution) that includes one or more constraints evaluated at one or more enforcement points. Example enforcement points include: (a) Pre-storage enforcement: prior to storing a new context record, the governance layer 620 may validate the record, set metadata defaults (e.g., a default consent state), and deny storage of disallowed content types. (b) Pre-retrieval enforcement: prior to selecting context records for reconstruction, the governance layer 620 may filter candidate records based on consent state, relevance value, source domain, contradiction indicators, and other policy rules. (c) Pre-presentation enforcement: prior to presenting reconstructed context to a user, the governance layer 620 may require contextual qualifiers (e.g., timestamps) and may enforce a silence state when the user has not requested resurfacing. (d) Action gating enforcement: prior to performing any system-initiated intervention (e.g., proactive prompts, external actions, or unsolicited surfacing of institutional signals), the governance layer 620 may require a user-initiated trigger and/or explicit confirmation. In some embodiments, the governance policy is stored as machine-readable rules, a policy graph, a configuration file, or other data structure that is separately auditable from the model inference engine 660.

### Relevance Decay Mechanism

The relevance decay mechanism 630 is configured to attenuate a relevance value associated with a context record over time and/or based on additional factors. In one non-limiting embodiment, each context record includes a timestamp and a decay parameter, and the relevance value is computed as a function of elapsed time since the timestamp. For example, a context record may be associated with an initial relevance value R0 and a decay coefficient lambda. The relevance value R(t) may be computed using an exponential decay function R(t)=R0*exp(−lambda*t), where t is a time duration since the timestamp. Other decay functions (e.g., linear decay, stepwise decay, or piecewise decay) may be used. In some embodiments, the relevance decay mechanism 630 also accounts for non-reaffirmation. For example, if a context record has not been reaffirmed by the user within a reaffirmation window, the decay coefficient may be increased or the record may be marked as dormant.

### Contradiction Indicators

In some embodiments, a context record includes a contradiction indicator. The contradiction indicator may be set based on user input (e.g., a user explicitly corrects or retracts prior information) and/or based on automated detection (e.g., a contradiction detection model or rule-based check). When a contradiction indicator is set, the relevance decay mechanism 630 may accelerate decay, and the governance layer 620 may require affirmative consent and/or additional qualifiers before reconstruction or presentation. In certain embodiments, contradicted records are not presented unless explicitly requested by the user.

### Consent Mediation and Consent State

The consent mediation module 640 manages consent for reconstruction of dormant or decayed context. In some embodiments, each context record includes a consent state indicating whether the record is: (a) allowed-eligible for reconstruction without additional consent; (b) required—eligible for reconstruction only upon receiving an affirmative consent signal; or (c) denied—not eligible for reconstruction. In some embodiments, a consent state can be updated based on user action. For example, a user may grant consent to re-enter a category of memories, revoke consent, or request a one-time consent for a specific record. The affirmative consent signal may be any explicit user action indicating approval, such as selection of a user interface control, a digital signature, or an explicit natural-language confirmation that is interpreted by a consent classifier and validated by the governance layer 620.

### Dormancy and Irretrievability

In some embodiments, a context record becomes dormant when its relevance value falls below a dormancy threshold, when it is marked as contradicted, and/or when it is marked as requiring consent. Dormant records may be excluded from active retrieval. In certain embodiments, dormant records are rendered irretrievable absent consent. Irretrievable, as used herein, includes preventing reconstruction through governance enforcement. In one non-limiting embodiment, a dormant record may be removed from a primary retrieval index, and a pointer to the record may be stored in a protected form that is accessible only upon affirmative consent. In another embodiment, the payload of a dormant record may be encrypted, and a key required for decryption may be made available only upon affirmative consent. These techniques reduce resurfacing of stale context and reduce retrieval overhead by narrowing eligible retrieval sets.

### Silence State and Authority Accretion Control

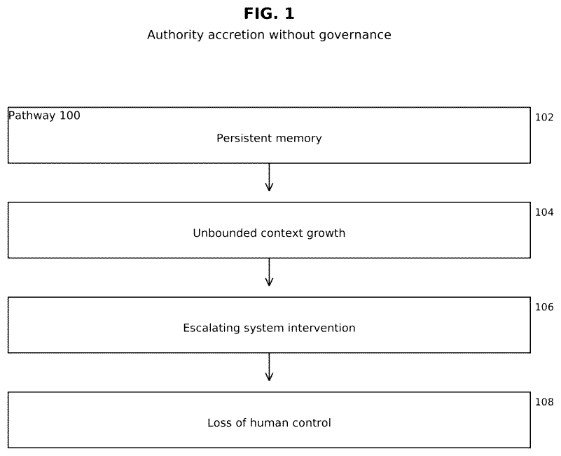

In some embodiments, the governance layer 620 enforces silence as a valid operational state. Silence may be enforced by withholding proactive output, withholding resurfacing of dormant context, and/or deferring outputs until a user provides a trigger or consent. In some embodiments, the system computes an authority accretion metric that represents a rate or degree of system-initiated interventions. The governance layer 620 may limit interventions based on the authority accretion metric, for example by enforcing a maximum intervention rate per time window or by requiring explicit confirmation before an intervention is performed. FIG. 1 illustrates a non-governed pathway 100 in which persistent memory 102 can lead to unbounded context growth 104, escalating system intervention 106, and loss of human control 108. The governed system prevents escalation by applying governance constraints, relevance decay, and consent gating.

### Governance-Constrained Context Lifecycle

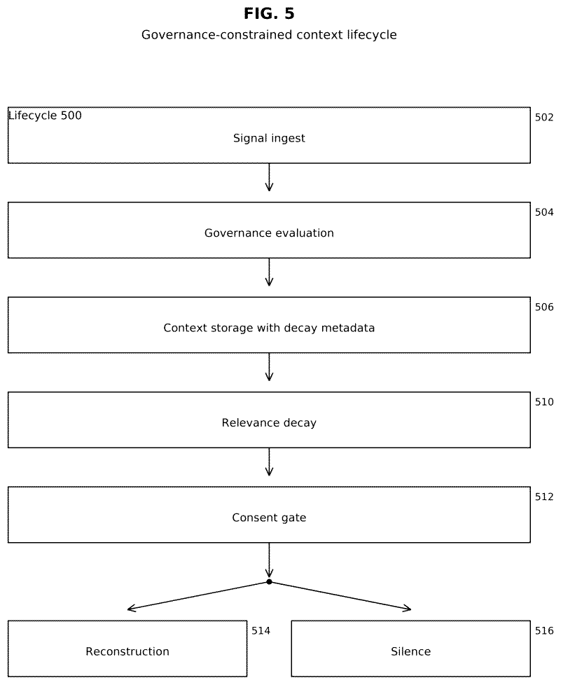

FIG. 5 illustrates a governance-constrained lifecycle 500 of contextual signals. In the illustrated embodiment, a signal is ingested 502 and evaluated by governance 504. If permitted, a context record is stored 506 with decay metadata 508. Over time, relevance decays 510. When a retrieval or reconstruction trigger occurs, the governance layer evaluates consent 512. If consent is provided and other constraints are satisfied, context is reconstructed 514. Otherwise, the system may remain in silence 516. The lifecycle may be applied to different categories of context records with different policies, decay parameters, and consent requirements.

### Institutional Signals and Inboxless Surfacing

In some embodiments, contextual signals include cross-domain institutional inputs such as signals from education, health, employment, finance, or other domains. The system may mediate such signals through governance constraints.

In one embodiment, the system surfaces institutional signals without a persistent inbox. For example, the system may use a transient presentation channel in which eligible signals are presented only upon a user request or within a current interaction session, without storing the signals in a long-lived message queue that continuously pushes notifications. This reduces unsolicited resurfacing and supports user-controlled timing.

### Scalability and Performance Benefits

Constraining retrieval and enforcing relevance decay can reduce computational load by limiting the number of candidate records considered during retrieval. For example, by excluding dormant records from active retrieval, the system may reduce embedding similarity computations, reduce index lookups, and reduce context window size provided to the model inference engine 660. In some embodiments, the system maintains a bounded eligible set size and/or uses decay metadata to prioritize recent and reaffirmed context records, thereby improving retrieval latency and scalability of persistent artificial intelligence systems.

### Example Embodiments and Use Cases

Non-limiting example embodiments include: (a) governed continuity companions that store user preferences with decay and consent gating; (b) institutional signal mediation systems that evaluate cross-domain signals and surface them only under governance constraints; (c) cross-domain opportunity surfacing without inbox-based delivery, where opportunities are surfaced within an interaction session rather than pushed as persistent notifications; and (d) consent-controlled memory re-entry, where historically stored context is reconstructed only when a user provides affirmative consent. These embodiments can be implemented with different policy profiles, consent interfaces, and decay functions.

### Computing Environment

The components described herein may be implemented using one or more computing devices having one or more processors and memory storing instructions. The system may include network interfaces for communicating with external domains and user devices. Persistent storage may include one or more databases, object stores, or distributed storage systems. The governance layer may be implemented as a policy engine, rules engine, or other executable logic that intercepts storage and retrieval requests. The described techniques can be applied to language-model-based systems, retrieval-augmented generation systems, and other machine learning systems that maintain continuity across sessions.

1. An artificial intelligence system comprising:
one or more processors; and a non-transitory computer-readable medium storing instructions that, when executed by the one or more processors, cause the system to:
(a) store, in a memory persistence layer, a plurality of context records representing contextual signals from interaction sessions, each context record including a payload and metadata that includes at least a timestamp and a consent state;
(b) enforce, by a governance layer separate from a model inference engine, one or more runtime governance constraints that condition at least one of storage, retrieval, and presentation of the context records;
(c) compute, by a relevance decay mechanism, a relevance value for each context record as a function of at least time since the timestamp and a decay parameter;
(d) in response to a retrieval trigger, select a candidate set of context records, filter the candidate set based on the governance constraints and the relevance values to produce an eligible set, and provide the eligible set to the model inference engine to generate an output; and
(e) when a context record has a relevance value below a dormancy threshold or a consent state requiring consent, block the context record from the eligible set unless an affirmative consent signal is received via a consent mediation module, and otherwise permit the system to enter a silence state in which no proactive output is generated.

2. The system of claim 1, wherein the governance constraints include a constraint that prohibits system-initiated interventions absent a user-initiated request, thereby enforcing silence as a valid operational state.

3. The system of claim 1, wherein the relevance value decays as a function of time and non-reaffirmation.

4. The system of claim 1, wherein the metadata includes a contradiction indicator, and wherein the relevance decay mechanism accelerates decay when the contradiction indicator is set.

5. The system of claim 1, wherein the consent state includes at least allowed, denied, and required, and wherein the consent mediation module requests the affirmative consent signal when the consent state is required.

6. The system of claim 1, wherein the governance layer filters the candidate set prior to performing ranking, scoring, embedding similarity search, or other retrieval optimization used to select context for reconstruction.

7. The system of claim 1, wherein the governance constraints prohibit computing or using an engagement metric to rank, select, or present the context records.

8. The system of claim 1, wherein the contextual signals include cross-domain institutional inputs.

9. The system of claim 8, wherein the system surfaces institutional inputs through a transient presentation channel without storing the institutional inputs in a persistent inbox data structure.

10. The system of claim 1, wherein the governance layer prevents automatic resurfacing of dormant context by requiring an explicit user request or the affirmative consent signal prior to reconstruction or presentation.

11. The system of claim 1, wherein a dormant context record is rendered irretrievable absent the affirmative consent signal by removing the dormant context record from an active retrieval index and making access to the dormant context record conditional on the affirmative consent signal.

12. The system of claim 1, wherein the governance constraints reduce computational retrieval load by limiting a maximum number of context records in the eligible set.

13. The system of claim 1, wherein the governance layer enforces the runtime governance constraints independently of a prediction accuracy of the model inference engine.

14. The system of claim 1, wherein the memory persistence layer maintains the context records across a period of user inactivity exceeding a threshold duration.

15. The system of claim 1, wherein continuity across interaction sessions is maintained without continuous authentication by associating the context records with a user identifier that is resolved upon a subsequent authentication event.

16. A computer-implemented method for operating a governed continuity intelligence system, the method comprising:
(a) ingesting contextual signals from a plurality of interaction sessions;
(b) storing the contextual signals as context records with metadata including a timestamp, a decay parameter, and a consent state;
(c) enforcing runtime governance constraints that condition storage, retrieval, and presentation of the context records;
(d) computing relevance values for the context records based on time and the decay parameter;
(e) filtering candidate context records for reconstruction based on the relevance values and the governance constraints; and
(f) reconstructing and presenting context from the filtered context records only upon receiving an affirmative consent signal for context records that are dormant or marked as requiring consent, and otherwise entering a silence state.

17. The method of claim 16, wherein enforcing the runtime governance constraints comprises treating silence as a valid system state in which the system generates no proactive output absent a user request.

18. The method of claim 16, wherein reconstructing context comprises attaching one or more contextual qualifiers derived from the metadata, the contextual qualifiers including at least a timestamp or a source domain identifier.

19. The method of claim 16, wherein enforcing the runtime governance constraints comprises limiting a rate of system-initiated interventions based on an authority accretion metric computed from prior system outputs.

20. A non-transitory computer-readable medium storing instructions that, when executed by one or more processors, cause performance of the method of claim 16.
